(19) United States
(12) Patent Application Publication
(10) Pub. No.: US 2022/0118640 A1
(43) Pub. Date: Apr. 21, 2022

(54) ROBOTIC CHOPSAW OR MERCHANDISER

(71) Applicant: Idaho Forest Group, LLC, Coeur d'Alene, ID (US)

(72) Inventors: Marc BRINKMEYER, Coeur d'Alene, ID (US); Chad KOSMICKI, Coeur d'Alene, ID (US); Jeremy FROMM, Coeur d'Alene, ID (US); Alex GOMEZ, Coeur d'Alene, ID (US)

(73) Assignee: Idaho Forest Group, LLC, Coeur d'Alene, ID (US)

(21) Appl. No.: 17/501,927

(22) Filed: Oct. 14, 2021

Related U.S. Application Data
(60) Provisional application No. 63/094,166, filed on Oct. 20, 2020.

(51) Int. Cl. B27B 1/00; B27B 5/36

(52) U.S. Cl. CPC B27B 1/00; B27B 31/006; B27B 5/36

(57) ABSTRACT

The technology disclosed relates a robotic workstations and methods for cutting timber. The robotic saw workstation can achieve improved cutting of timber. In one configuration, the robotic saw workstation includes a robot manipulator capable of moving an end effector adapter plate to points in a three-dimensional work volume under programed control of a programmable robot controller executing stored instructions. A cutting head is affixed to the end effector adapter plate. The cutting head further includes a support structure; a rotatable shaft; a blade coupled to the rotatable shaft; and a motor coupled to the rotatable shaft for driving the blade. Configurations include multiple manipulators disposed to make multiple cuts in a log substantially contemporaneously, cutting heads implementing circular, band or chain sawing mechanisms, continuous or batch-feeding of logs into and out of the workstations.

### PRIORITY

This application claims the benefit of U.S. Provisional Patent Application No. 63/094,166, entitled, “ROBOTIC CHOPSAW OR MERCHANDISER,” filed on Oct. 20, 2020 (Atty. Docket No. IDFG 1005-1). The priority application is hereby incorporated by reference herein for all purposes.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Processing timber involves a variety of tasks, such as sawing, packaging, and shipping product and the like. During processing, wooden logs are cut to various sizes in a timber mill or other facility. Often, large stationary saw blades are used for this task. One problem with these traditional approaches is that the raw timber can be of various sizes and geometries, making the task difficult for fixed position saw blades. The lack of flexibility is also compounded by the complexity of materials handling requirements for the timber. Rough cut timber is heavy and unwieldy, making the job of moving it into and out of the work area complex.

Conventional approaches to the problem of cutting timber are not flexible, nor scalable, nor cost effective, and are of very low efficiency, making their usage in scalable timber processing installations problematic. Often, conventional approaches require a variety of different inflexible machines to perform the same task on different sizes of logs. Sometimes, conventional approaches require additional energy to be expended moving timber among a larger variety of machines to perform processing.

An opportunity arises to develop better machines and processes for processing logs into wood products. Better, more easily operated, more effective and efficient apparatus and systems may result.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of this summary is to present some concepts related to some exemplary non-limiting implementations in a simplified form as a prelude to the more detailed description of the various implementations that follow.

The technology disclosed relates to a robotic workstations and methods for cutting timber. The robotic saw workstation can achieve cutting large logs of indefinite length (e.g., logs of 55 feet in length are can be processed by one implementation of the robotic saw workstation). In one configuration, the robotic saw workstation includes a robot manipulator capable of moving an end effector adapter plate to points in a three-dimensional work volume under programmed control of a programmable robot controller executing stored instructions. A cutting head is affixed to the end effector adapter plate. The cutting head further includes a support structure, a rotatable shaft, a blade coupled to the rotatable shaft, and a motor coupled to the rotatable shaft for driving the blade. Configurations include multiple manipulators disposed to make multiple cuts in a log substantially contemporaneously, cutting heads implementing circular, band or chain sawing mechanisms, continuous or batch-feeding of logs into and out of the workstations and the like.

In a particular implementation, the technology disclosed also provides a method of cutting large logs of up to 55 feet in length. The method can include depositing the log on a materials handling system conveying the log into an infeed side of a work envelope of a robotic workstation. The robotic workstation having a manipulator for reaching points within the work envelope using a cutting tool affixed to an end effector thereof. At least one cut of the log by the cutting tool as moved by the manipulator is performed according to the method. The method further includes removing a cut portion of the log from an outfeed side of the work envelope using the materials handling system.

In one implementation, 3 robot manipulators (i.e., saws) working independently can saw a 40-foot log. Various other combinations of log length and number of robotic manipulators can be implemented depending on requirements of the sawmill.

Further provided by the disclosed technology is a cutting head implementation that can be affixed to an adapter plate of a robot manipulator capable of moving an end effector adapter plate to points in a three-dimensional work volume under programmed control of a programmable robot controller executing stored instructions for cutting logs. The cutting head can include a support structure affixable to the adapter plate of a robot manipulator. The cutting head can also include at least one rotatable shaft. A sawblade including at least one of a circular blade, a chain blade, or band blade, is coupled to the at least one rotatable shaft and driven in a cutting motion. A motor is coupled to the rotatable shaft for driving the sawblade.

A yet further implementation provides a robotic saw workstation for cutting logs is disclosed. An implementation of the robotic saw workstation includes first and second robot manipulators. The first robot manipulator capable of moving a first cutting head to points in a three-dimensional work volume under programmed control of a programmable controller executing stored instructions. The first cutting head includes: a support structure; a rotatable shaft; a blade coupled to the rotatable shaft; and a motor coupled to the rotatable shaft for driving the blade. The second robot manipulator capable of moving a second cutting head to points in a three-dimensional work volume under programmed control of the programmable controller executing stored instructions. The second cutting head includes: a support structure; a rotatable shaft; a blade coupled to the rotatable shaft; and a motor coupled to the rotatable shaft for driving the blade. A materials handling system that moves workpieces into the work volume and cut workpieces out of the work volume is also part of the workstation. A programmable controller executing stored instructions instructs the first robot manipulator and first cutting head, the second robot manipulator and the second cutting head to cut a same log positioned by the materials handling system substantially contemporaneously.

Particular aspects of the technology disclosed are described in the claims, specification and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates a right-side view of a robotic workstation for cutting timber.

FIG. 2 illustrates another right-side view of a robotic workstation for cutting timber.

FIG. 3 illustrates a left-side view of a robotic workstation for cutting timber.

FIG. 4 illustrates a left-quarter perspective view of a robotic workstation for cutting timber.

FIG. 5 illustrates a right-side view of a cutting head of robotic workstation for cutting timber.

FIG. 6 illustrates a right-quarter perspective view of a cutting head of a robotic workstation for cutting timber.

FIG. 7 illustrates an outfeed side view of tandem robotic workstations for cutting large logs using band saws.

FIGS. 8A and 8B show implementation of an electronics architecture used by the robotic workstation in which a controller processes input data comprising at least actuation data from actuators of an actuation system, image data from visual sensors in the robot workstation, and tactile data from tactile sensors in the robotic workstation, and generates actuator command data.

### DETAILED DESCRIPTION

The following description will typically be with reference to specific structural embodiments and methods. It is to be understood that there is no intention to be limited to the specifically disclosed embodiments and methods but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

A more sophisticated robotic sawmill and method is provided for improved efficiency in processing logs into wood products. Implementations efficiently cut logs of approximately 55 feet in length. Our approach is scalable and can be configured in implementations that cut logs of 4 feet in length to 80 feet in length. Some implementations are configured to work with logs greater than 80 feet in length. Prior to cutting, a section length can be determined and then the number of cuts and robots (i.e., robot manipulators) involved in the cutting is determined. For example, one robotic sawmill implementation can make cuts spaced 8 feet apart on a 40-foot log using 4 robotic sawblades, where the 4 cuts are performed substantially contemporaneously, by the means of the robot manipulators capable of moving and/or positioning the saw blades to cut logs at high speeds (e.g., up to 1,750 rpm) thereby enabling log cutting to be achieved at greater efficiency.

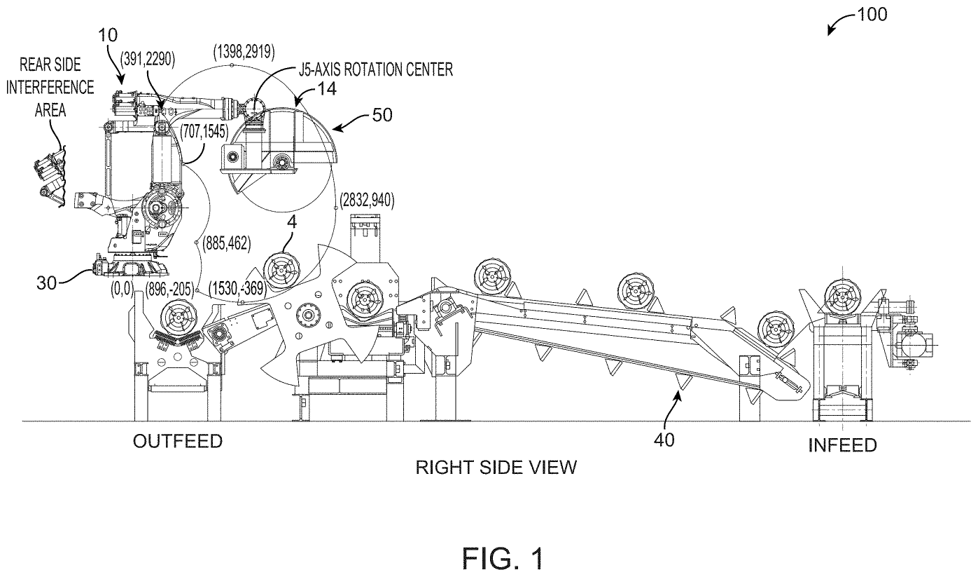

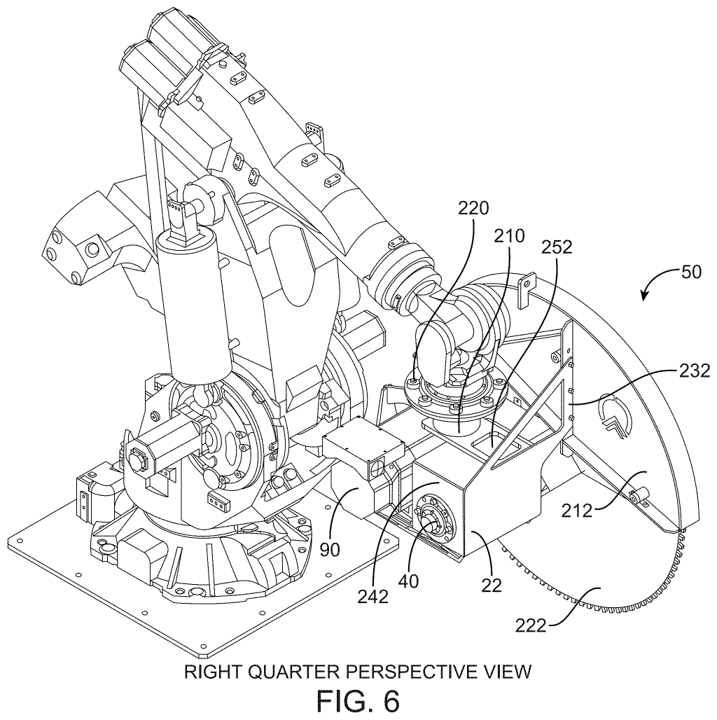

FIG. 1 illustrates a right-side view of a robotic workstation 100 for cutting timber. Robotic workstation 100 nominally includes a robot manipulator 10 including a base 30 that can be affixed to the sawmill floor directly or via a platform (not illustrated). Note that the location of the robot manipulator 10 in FIG. 1 is only for illustrative purposes, as the base 30 can be directly or indirectly affixed to the sawmill floor. (In the example depicted, base 30 is shown affixed directly to the sawmill floor. Alternatively, there would be a fabricated base, not shown for clarity sake, that would be positioned between base 30 and the floor). A robot controller (not shown in FIG. 1 for clarity sake; see FIGS. 6A and 6B) controls the motions of robot manipulator 10 under direct operator control and/or by programmed logic. A cutting head 50 is coupled to the robot manipulator 10 and is enabled to move within work envelope 14 to cut product 4 fed by materials handling system 40 under control of the robot controller. Points indicated at edges of work envelope 14 are indicated in millimeters with respect to an origin point (0,0) defined at the robot body as shown in FIG. 1. Of course, other work envelope sizes and configurations can be used in various configurations without departing from the spirit and scope of our disclosed technology.

Robot manipulator 10 is preferably an industrial grade articulating 6-axis robot arm (manipulator) capable of moving laterally approximately +/−4 feet from a starting position. Implementations enable cutting logs into approximately 8-to-20-foot sections. Some implementations can cut logs up to 20 feet (or more, depending upon the length and movement capabilities of the articulating robot arm of the robot manipulator 10) and as small as 48 inches. In one implementation 4 saws can be arranged to saw a 40-foot log independently into 5 eight-foot sections. In one implementation, a highly customized FANUC M-2000IA/2300 robot serves as a robot manipulator. In one implementation, robot manipulator 100 includes feedback from servos that drive motions of the robot, such as torque, arbor speed, robot force exerted, collision detection and others. Other implementations can be realized using any of a set of industrial-purpose commercially available robots made by Fanuc, ASEA, Kuka, ABB, Yaskawa and the like.

Material handling system 40 can be a continuous materials handling system, e.g., conveyors and like implementing relatively continuous flow of materials, or non-continuous, e.g., batch fed operations, etc.; materials handling system 40 preferably includes conveyors, indexers, and the like to move logs into the workstation 100 and to move cut logs out of the workstation 100.

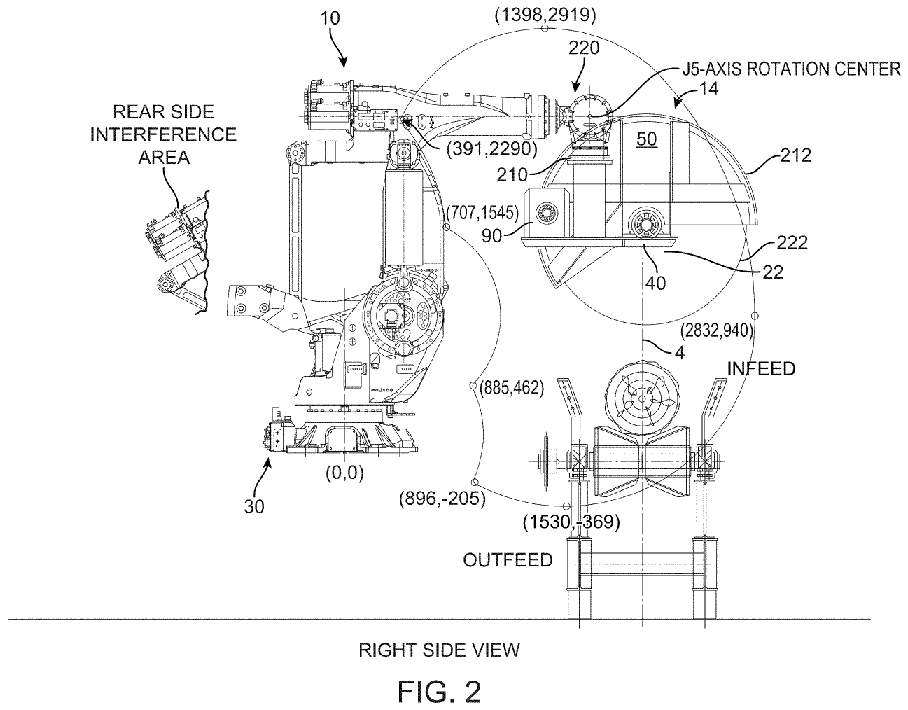

FIG. 2 illustrates another right-side view of a robotic workstation for cutting timber in a slightly different configuration. Cutting head 50 includes a blade 222 and blade guard 212 coupled to a structure 22. Blade 222 is fixed to a rotatable shaft arrangement 40 enabling the blade 222 to be turned under the drive of a motor 90. A support stanchion 210 couples the cutting head 50 to an end effector adapter plate 220 of robot manipulator 10. In one implementation, blade 222 includes a 54-inch diameter blade. Some implementations employ a 60-inch diameter blade. Other implementations utilize an 84-inch diameter blade. Smaller blades can also be selected and implemented based on the size of timber processed buy the sawmill. In one implementation, blade 222 is capable of rotation speeds of up to 1,750 revolutions per minute (rpm). Some implementations employ a range of rotational speeds for the blade 222 including operating at between 0 rpm and 1,750 rpm.

In one implementation, blade 222 cuts a kerf of 0.50 inches. Other configurations of blade size used in some implementations. For example, some implementations use blades having a kerf in a range between 0.125″ to 0.75″ or about ¾″. Blade 222 can be made of steel, and can include carbide tipped teeth.

Motor 90 is electrically driven using power conducted by cabling from a source and dropped in overhead or via conduits through walls or flooring and can nominally output 150 hp. Motors having power outputs in a range of 5 to 150 horsepower can be used in some implementations.

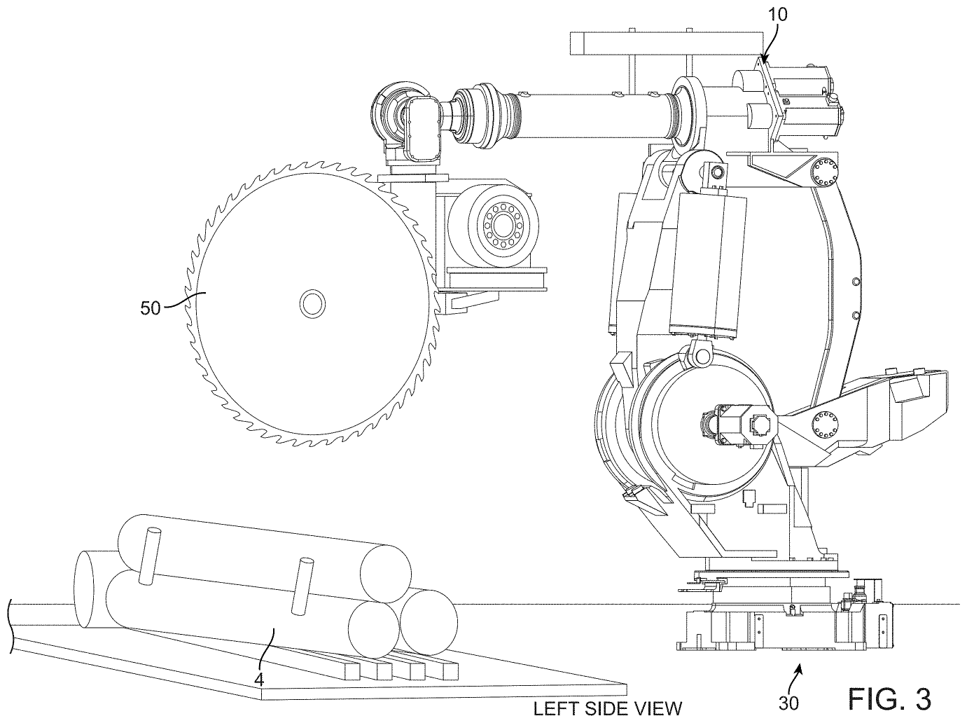

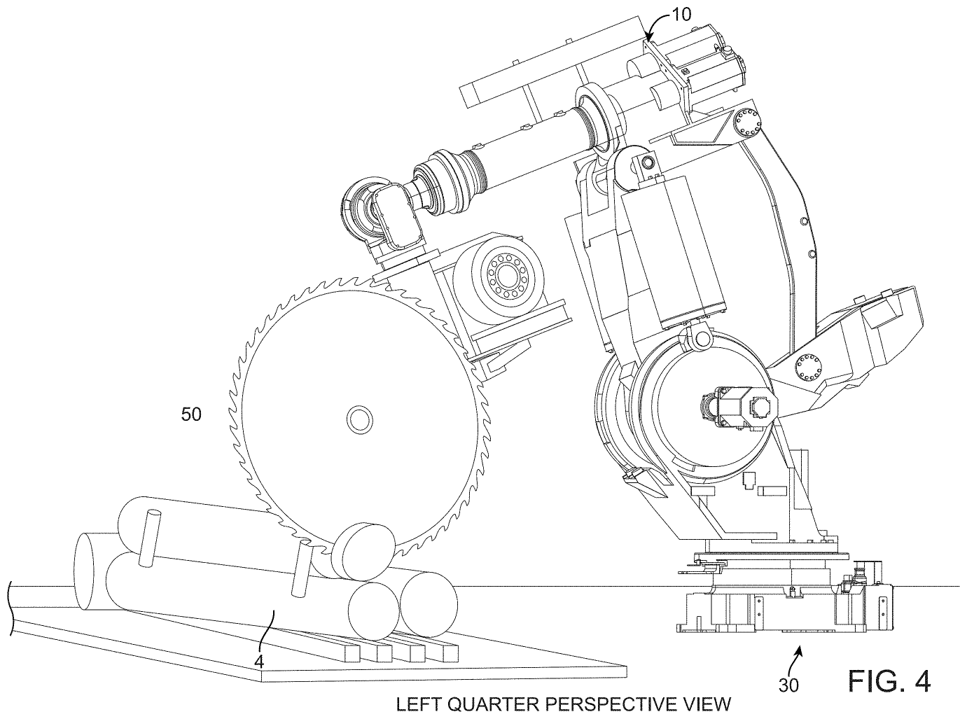

FIG. 3 illustrates a left-side view of a robotic workstation for cutting timber. In the configuration illustrated by FIG. 3, a cutting operation is performed on a top log supported by additional logs 4. In alternative implementations, support logs are not used and a log is cut individually when supported by a jig or fixture in the sawmill. With continuing reference to FIG. 3, manipulator 10 is set in a first position (“ready pose”) in which a distance between blade 50 and workpiece(s) 4 is at a maximal amount given the work envelope. In this position, the work envelope is clear of obstruction and workpieces 4 can be moved into the work envelop for cutting, or out of the work envelope once cut. While workpieces 4 are depicted as fed in a batch, e.g., three logs, other implementations can include instead continuous materials handling to feed workpieces 4 into the work envelope. Once the workpiece(s) 4 are situated in the work envelope, manipulator 10 moves the saw blade 50 into a second position (“cutting pose”) enabling the blade 50 to engage the workpiece 4 to make a cut, as illustrated by FIG. 4.

FIG. 4 illustrates a left-quarter perspective view of a robotic workstation for cutting timber. While illustrated in FIG. 4 as substantially vertical, blade 50 can be inclined at an angle from the vertical plane enabling the saw to cut workpieces at an angle. In one robotic saw workstation implementation, the plane of the sawblade forms an angle between 1 degree and 10 degrees with respect to a vertical plane. In some configurations, the sawblade is capable of making cuts at angles greater than 10 degrees with respect to the vertical plane. Such configurations implement a smaller tool arm, larger robot arm or combinations thereof. Some configurations can be realized with the angles of between 10 degrees and 90 degrees to the vertical plane. As used herein, the vertical plane is essentially orthogonal to a surface upon which the robotic saw workstation resides. In one robotic saw workstation implementation, the angle is inclined from the vertical plane to an input side of the robotic saw workstation, e.g., the top of blade 50 inclined further to the robot's right in FIG. 4. In one robotic saw workstation implementation, the angle is inclined from the vertical plane to an output side of the robotic saw workstation, e.g., the top of blade 50 inclined further to the robot's left in FIG. 4.

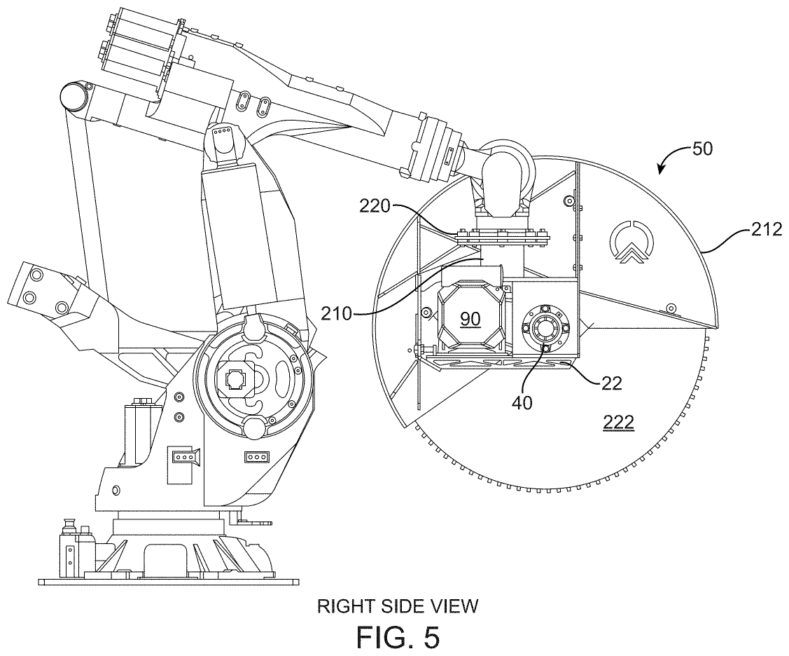

FIG. 5 illustrates a right-side view of a cutting head of robotic workstation for cutting timber. As shown, cutting head 50 affixed to an adapter plate 220 of the robot manipulator 10. The robot manipulator 10 is capable of moving end effector adapter plate 220 and hence cutting head 50 to points in a three-dimensional work volume 14 (of FIG. 2) under programmed control of a programmable robot controller executing stored instructions for cutting logs 4 (of FIG. 2) (not shown in FIG. 5 for clarity sake). A support stanchion 210 couples the cutting head 50 to an end effector adapter plate 220 of robot manipulator 10. The support stanchion 210 couples to a support structure 22 that attaches and supports the other components of cutting head 50. Cutting head 50 includes a sawblade 222 of a circular blade configuration. Other configurations, employing a chain blade, or band blade, are also realizable. The sawblade 222 is coupled to the at least one rotatable shaft 40 and driven in a cutting motion by motor 90 coupled to the rotatable shaft 40 for driving the blade.

FIG. 6 illustrates a right-quarter perspective view of a cutting head of a robotic workstation for cutting timber. As shown, a different view of cutting head 50, affixed to an adapter plate 220 of the robot manipulator 10, illustrates the relationships between components. Support structure 22 includes a bracket 232 for attaching and supporting blade guard 212. Support structure 22 also includes a housing covering 242 moving portions of drive assembly including rotable shaft 40 and pulleys, gears or other driving arrangements between shaft 40 and motor 90. Support structure 22 further includes attachment surfaces for attaching stanchion 210, which in turn attaches cutting head 50 to adapter plate 220 of robot manipulator 10. In one implementation, support structure 22 is fabricated using ½ inch plate steel. However, thicknesses from ¼ inch to 2 inches maybe be used. Further in some implementations, stainless steel, aluminum in lighter duty application, or polycarbonate can also be used.

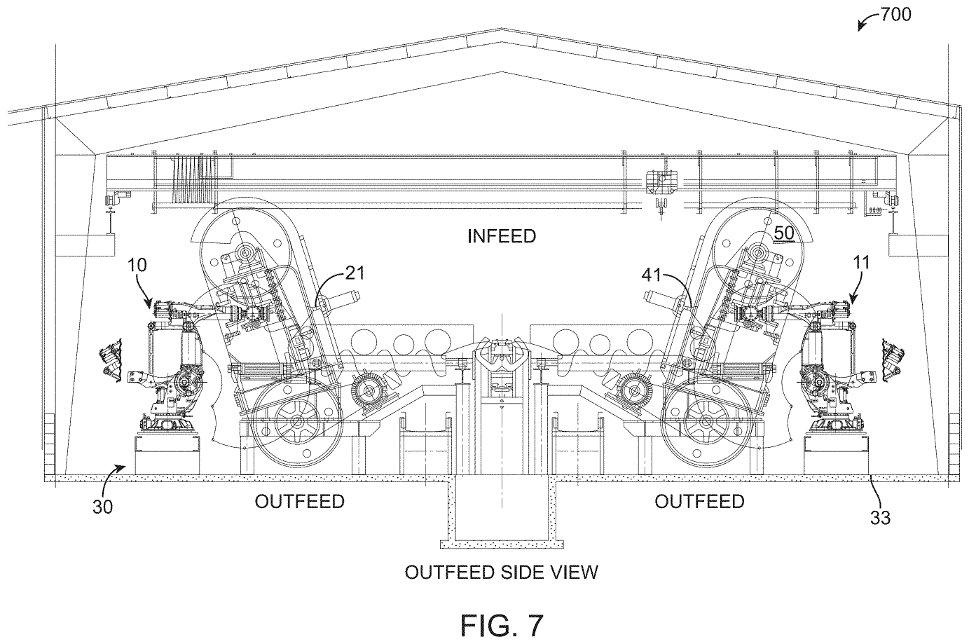

FIG. 7 illustrates an alternative implementation, workstation 700, in which robot manipulators 10, 11 from respective workstations 30, 33 utilize band saws 21, 41 to break down logs to cants or lumber. Each manipulator 10, 11 can pick up a log from both ends and move the log through the respective band saws 21, 41. Other implementations will be apparent to a person of ordinary skill in the art. For example, the band saw blade described above can be replaced by a chain-type saw.

Additional features included in various implementations of the robot saw workstation 100 include the use of sensors such as (i) force sensors that are implemented to dynamically adjust the speed of the downward motion of the saw blade as the saw blade penetrates the log, (ii) current transducers allowing the saw motor to dynamically adjust the speed of the down motion and (ii) area sensors for detection of entry into a danger zone. Additionally, the time per cut can vary based o log diameter and motor size, where the robotic workstation 100 is capable of adaptation to various motor sizes, depending on current requirements of the mill. Motors can be changed or swapped based on various requirements. The robot manipulators 10 (e.g., robot arms) and blades can be selected and implemented based on the requirements (e.g., volume throughput) of the mill. The travel speed of the blade (e.g., 9 inches per second) as it is cutting can be adjusted based on the circumstances and requirements of the mill. One implementation includes cutting speeds in a range of 0.05 inches per second to 24 inches per second.

As mentioned above, multiple robot manipulators (or robotic workstations) can be combined, such that the robot manipulators are spaced apart by, for example 8 feet. For sake of clarity, a single robot workstation can include multiple robot manipulators, or as mentioned above, multiple robotic workstations can be implemented, where each robot workstation includes a single robot manipulator. The number of robot manipulators is dictated by the maximum length of the log. The robot manipulators can be coordinated to perform cuts at approximately the same time. An example system can handle a 43-foot log, with 5 robots that can produce any combination of lengths between 8 foot and 20-foot sections. Logs can be optimized for length at a minimum to determine where each saw blade (robot manipulator) would need to cut. This information is calculated and then passed from a programmable logic controller (PLC) to each of the robot manipulators for initial positioning and subsequent cutting.

### Electronics Architecture

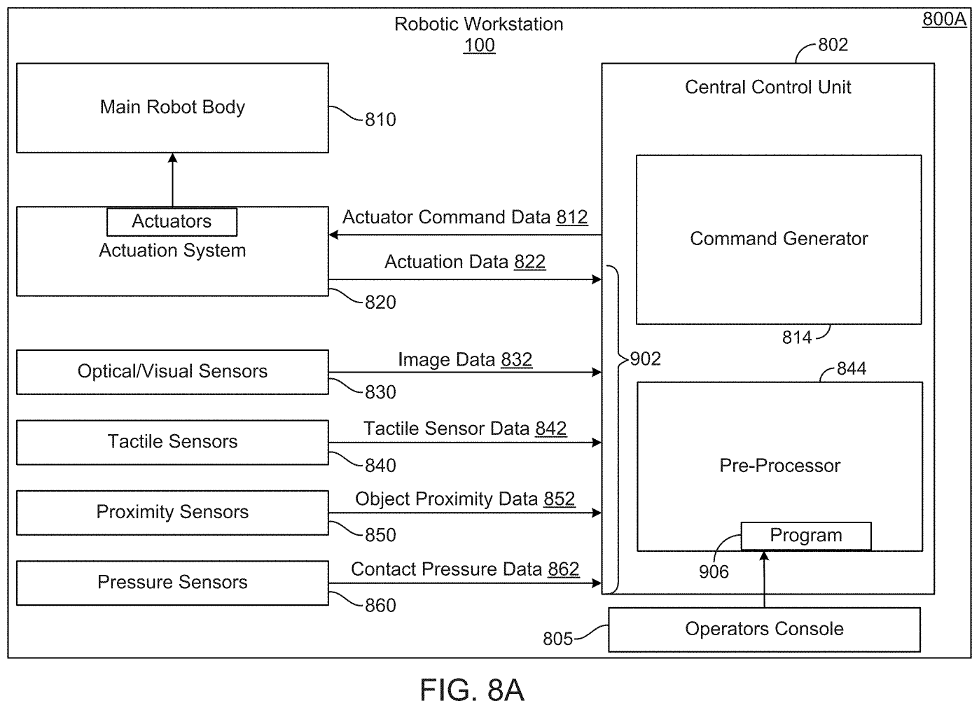

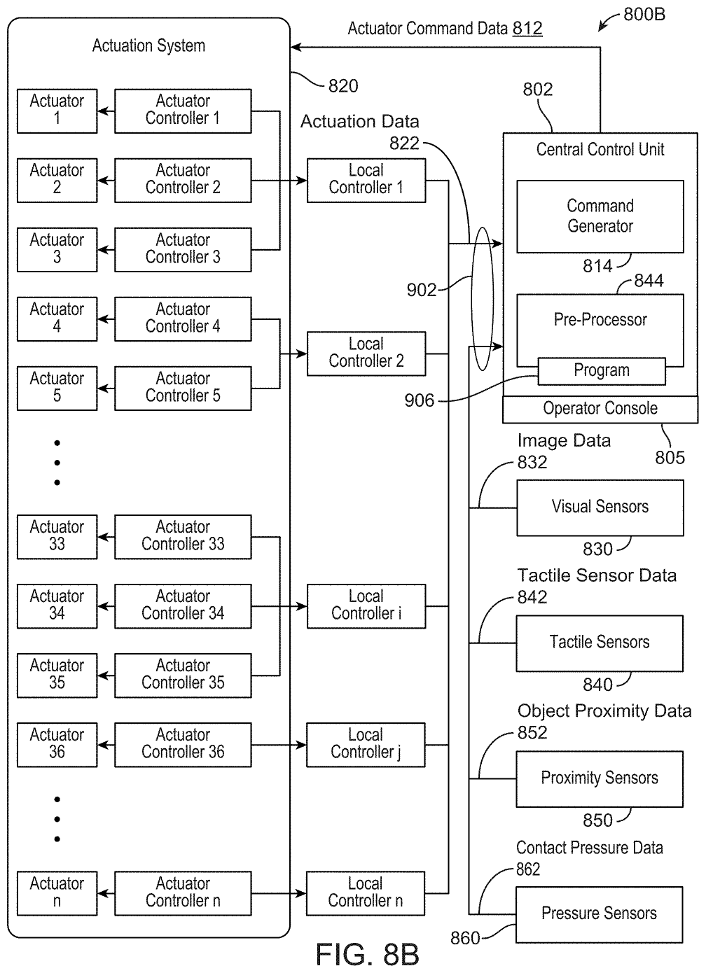

FIG. 8A is a simple functional block diagram of the robotic workstation 100. In FIG. 8A, the electronics architecture 800A comprises the central control unit 802 that controls the actuators (e.g., that control manipulators, such as the robotic manipulator 10) including sources of motive force and, therefore the linkages, joints, and gripper/end effector, etc. of the robotic workstation 100, using the command generator 814 and/or the pre-processor 844.

The robotic workstation 100 includes main robot body 810, including the kinematic chain, and the actuation system 820. The robotic workstation 100 includes a central control unit 802 (i.e., controller) that in this example comprises a command generator 814 and a pre-processor 844. The controller is in communication with the plurality of actuators and the sensors, and operates the components on the kinematic chain. The controller includes a feedback loop receiving feedback data derived from or including the actuator data and sensor data as feedback input, trained to generate actuator command data 812 to cause the robotic workstation 100 to execute a task to manipulate the object responsive to the feedback data, under direct operator control and/or by programmed logic. Implementation specifics vary considerably, however in one example a Controllogix™ PLC is used to implement the central control unit 802. Training may be implemented using programming by an operator at operators console 805. In other embodiments, machine learning algorithms and techniques are used to generate, or augment existing, commands to the robotic workstation 100.

The actuation system 820 can include sources of motive force, e.g., electric motors, hydraulic cylinders, pneumatic cylinders and the like, coupling actuators, e.g., linkages, springs, levers, and so forth, and sensors affixed to one or the other, e.g., encoders, position sensors, combinations thereof, or the like. The actuation system 820 provides actuation data 822 to the central control unit 802, and receives actuator command data 812, including actuator commands, from the central control unit 802. Also, the robotic workstation 100 includes as describe above, optical/visual sensors 830 generating image data 832 and range data, tactile sensors 840 in this example generating tactile sensor data 842, proximity sensors 850 in this example generating object proximity data 852 relative to the end effectors, and pressure sensors 860 in this example generating contact pressure data 862. The actuation data 822, the image data 832, the tactile sensor data 842, the object proximity data 852, and the contact pressure data 862 are provided to the central control unit 802.

The command generator 814 can plan motion of components of the robotic workstation 100, such as the robotic manipulator 10 and use this motion plan to generate a sequence of commands commanding the joints of the robotic workstation 100 for the purposes of advancing the robotic workstation 100 to a goal state provided by the pre-processor 844 to the command generator 814.

The pre-processor 844 can process the actuation data 822, the image data 832, the tactile sensor data 842, the object proximity data 852, and the contact pressure data 862 to produce a state vector for the robotic workstation 100. This state vector is produced in a time frame and manner as needed to control the state of the robotic workstation 100 and is accessible to task programming provided to the robotic workstation 100 via the operators console 805. The pre-processor 844 can include one or more trained neural networks used for the purpose of deriving feedback data for input the neural network that generates the command data. Also, the command generator can include one or more trained neural networks. In some implementations, the command generator and the pre-processor comprise neural networks trained end-to-end using reinforcement learning. Other training procedures can be applied as well, including separate training of the neural networks in the controller.

Thus, the central control unit 802 processes input data comprising at least the actuation data 822 from the actuators of the actuation system 820, the image data 832 from the visual sensors 830 if present, and if present, other sensor data such as the tactile sensor data 842 from the tactile sensors 840 of the robotic workstation 100, and generates actuator command data 812.

In some implementations, with reference to FIG. 8B, the electronics architecture 800B further comprises distributed local controllers that are responsible for low-level motor control, including current, velocity, and position control, evaluation of the joint sensors, output control signals to the actuator power electronics, parameterization of the actuator controllers, e.g., for gain scheduling, and data acquisition from the force/torque sensors and inertial measure measurement system. Each local controller can handle a set of actuators (e.g., one, two, or three actuators). Cable harnesses connect the actuator sensors, actuators, drives to the local controllers. The central control unit 802 and the local controllers can communicate by a high-speed communication interface such as CAN, FireWire, or SERCOS, supporting real-time control in which each new set of actuator commands is based on feedback data that indicates the effects of the immediately preceding command set on the pose of the robot and the object of the task.

### Controller

The central control unit 802 includes the command generator 814 and the pre-processor 844, in this example, implementing a control loop that includes processing the input data for an instant time interval, and generating the actuator command data 812 for use in a next time interval.

The central control unit 802 is also configured with a system file including a program file (e.g., program file 906) that specifies the task(s) to be executed by the robotic workstation 100. The program file can identify the task in a sequence of sub-tasks, along with goal positions, goal angles, maximum and minimum values for sampling the goal positions and the goal angles, policy paths and trajectories, policy speedup coefficients, and feedback actions. Each “task” can be implemented to be triggered based upon a set of detected input conditions, duty cycle, operator command issued at the operators console 805 or otherwise. In one implementation, a set of weights generated by training a neural network system, including a trained neural network in a feedback loop receiving feedback data derived from or including the actuator data and the sensor data as feedback input, trained to generate actuator command data to cause the robot to execute the task to manipulate the object, or the robot in preparation for manipulation of an object, in response to the feedback data. The neural network system that can be trained using reinforcement learning algorithms and configured with a policy that implements the control feedback loop. The neural network system can use neural networks like a multi-layer perceptron (MLP), a feed-forward neural network (FFNN), a fully connected neural network (FCNN), a convolutional neural network (CNN), and a recurrent neural network (RNN). Example of the reinforcement learning algorithms include deterministic policy gradient algorithms, and policy-gradient actor-critic algorithms like deep deterministic policy gradient (DDPG) with hindsight experience replay (HER) and distributed distributional deterministic policy gradient (D4PG).

The input data 902 can includes the range image data 832 from the visual sensors 830 indicating the orientation and position of the timber and the robotic manipulator 10 in three dimensions and time, and the actuation data 822 from the actuators of the actuation system 820. The input data 902 can further include the tactile sensor data 842 from the tactile sensors 840 in the robotic manipulator 10 or other components of the robotic workstation 100. The input data 902 can further include the object proximity data 852 from the proximity sensors 850. The input data 902 can further include the contact pressure data 862 from the pressure sensors 860. The input data 902 can further include external motion tracking data from an external, stand-alone motion tracking system like OptiTrack™ type motion capture system that tracks motion of the robotic workstation 100 and the object in a three-dimensional space. The input data 902 can be used as feedback data in the feedback loop, and can be used to derive feedback data, and both.

The actuator command data 812 updates one or more of the actuator parameters of the actuators. Examples of the actuator command data 812 include position updates, absolute positions, angle updates, absolute angles, torque updates, absolute torques, speed updates, absolute speeds, velocity updates, absolute velocities, acceleration updates, absolute accelerations, rotation updates, and absolute rotations. The actuator command data 812 is used to update the respective states of the actuators in the next time interval, which in turn causes the tendons, the joints, the body parts, and other components of the robotic workstation 100 to transition to a different state (e.g., tension, position, orientation) in the next time interval.

The actuator command data 812 can include commands for each of the actuators or only a subset of the actuators. Each command can include an actuator ID, and a numerical value or values used to drive the actuator to a next state.

In the implementation listed above, the actuator command data 812 provided as output of the controller comprising a vector of drive changes for differential positioning, or a vector of position mode target positions, or a vector of force/torque values, and various combinations of differential mode commands, position mode command as suitable for the actuators under control.

The actuators execute the commands specified in the actuator command data 812 and generate the actuation data 822 for the next time interval, and cause generation of the image data 832 by the visual sensors 830 and the tactile sensor data 842 by the tactile sensors 840 for the next time interval. The process is iterated by the control loop implemented by the controller 830.

In some implementations, the actuator command data 812 generated by the controller 802 is processed by a calibration module (not shown) that generates a calibrated version of the actuator command data 812 which is specific to the configuration of the robotic workstation 100. The calibrated version of the actuator command data is used to update the respective states of the actuators.

Additional features included in various implementations of the robotic workstation 100 include the use of sensors such as (i) encoders for movement measurement of various components of the robotic workstation 100; (ii) current transducers allowing the system to automatically detect a stall or jamb condition of a robotic manipulator and signal for assistance; and (ii) area sensors for detection of entry into a danger zone.

### Some Particular Implementations

We describe various implementations of robotic saw workstation.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A system implementation of the technology disclosed includes a robotic workstation for cutting timber. The robotic saw workstation can achieve cutting large logs of up to 55 feet in length. In one configuration, the robotic saw workstation includes a robot manipulator capable of moving an end effector adapter plate to points in a three-dimensional work volume under programed control of a programmable robot controller executing stored instructions. A cutting head is affixed to the end effector adapter plate. The cutting head further includes a support structure; a rotatable shaft; a blade fixed to the rotatable shaft; and a motor coupled to the rotatable shaft for driving the blade.

This system implementation and other systems disclosed optionally include one or more of the following features. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

One robotic saw workstation implementation further includes a materials handling system moving workpieces into the work volume and cut workpieces out of the work volume.

In one robotic saw workstation implementation, a second robotic saw workstation is disposed relative to the materials handling system to cut a same log substantially contemporaneously with the first robotic saw workstation.

In one robotic saw workstation implementation, a third robotic saw workstation is disposed relative to the materials handling system to cut the same log substantially contemporaneously with the second robotic saw workstation and the first robotic saw workstation.

In one robotic saw workstation implementation, a selectable speed range includes a speed of 0 revolutions per minute (rpm) to 1,750 (rpm).

In one robotic saw workstation implementation, a kerf cut by the blade in wood output from the robotic saw workstation is in a range between 0.125 inches to 0.75″ inches.

In one robotic saw workstation implementation, the blade is selected from at least one of a 54-inch blade, a 60-inch blade, and an 84-inch blade.

In one robotic saw workstation implementation, the plane of the sawblade forms an angle between 1 degree and 10 degrees with respect to a vertical plane.

In one robotic saw workstation implementation, the vertical plane is essentially orthogonal to a surface upon which the robotic saw workstation resides.

In one robotic saw workstation implementation, the angle is inclined from the vertical plane to an input side of the robotic saw workstation.

In one robotic saw workstation implementation, the angle is inclined from the vertical plane to an output side of the robotic saw workstation.

A method implementation of the technology disclosed includes a method of cutting large logs of up to 55 feet in length. The method can include depositing the log on a continuous (or non-continuous, batch-fed) materials handling system conveying the log into an infeed side of a work envelope of a robotic workstation. The robotic workstation having a manipulator for reaching points within the work envelope using a cutting tool affixed to an end effector thereof. At least one cut of the log by the cutting tool as moved by the manipulator is performed according to the method. The method further includes removing a cut portion of the log from an outfeed side of the work envelope using the continuous (or non-continuous, batch-fed) materials handling system.

Each of the features discussed in this particular implementation section for the first system implementation apply equally to this method implementation. As indicated above, all the system features are not repeated here and should be considered repeated by reference.

Other implementations may include a non-transitory computer readable storage medium storing instructions executable by a processor to perform a method as described above. Yet another implementation may include a system including memory and one or more processors operable to execute instructions, stored in the memory, to perform a method as described above.

In one implementation of our method, the selectable speed range includes a speed of 0 revolutions per minute (rpm) to 1,750 (rpm).

In one implementation of our method, multiple cuts are performed to a log by multiple cooperatively acting cutting tools substantially contemporaneously.

In one implementation of our method, the cutting is performed at an angle between 1 degree and 10 degrees with respect to a vertical plane.

In one implementation of our method, the vertical plane is essentially orthogonal to a surface upon which the robotic saw workstation resides.

In one implementation of our method, the angle is inclined from the vertical plane to an input side of the robotic saw workstation.

In one implementation of our method, the angle is inclined from the vertical plane to an output side of the robotic saw workstation.

In one implementation of our method, three (3) robotic saws saw a 40-foot log independently.

A cutting head affixed to an adapter plate of a robot manipulator capable of moving an end effector adapter plate to points in a three-dimensional work volume under programmed control of a programmable robot controller executing stored instructions for cutting logs. The cutting head can include a support structure affixable to the adapter plate of a robot manipulator. The cutting head can also include at least one rotatable shaft. A sawblade including at least one of a circular blade, a chain blade, or band blade, is coupled to the at least one rotatable shaft and driven in a cutting motion. A motor is coupled to the rotatable shaft for driving the sawblade.

A robotic saw workstation for cutting logs is disclosed. An implementation of the robotic saw workstation includes first and second robot manipulators. The first robot manipulator capable of moving a first cutting head to points in a three-dimensional work volume under programmed control of a programmable controller executing stored instructions. The first cutting head includes: a support structure; a rotatable shaft; a blade coupled to the rotatable shaft; and a motor coupled to the rotatable shaft for driving the blade. The second robot manipulator capable of moving a second cutting head to points in a three-dimensional work volume under programmed control of the programmable controller executing stored instructions. The second cutting head includes: a support structure; a rotatable shaft; a blade coupled to the rotatable shaft; and a motor coupled to the rotatable shaft for driving the blade. A materials handling system that moves workpieces into the work volume and cut workpieces out of the work volume is also part of the workstation. A programmable controller executing stored instructions instructs the first robot manipulator and first cutting head, the second robot manipulator and the second cutting head to cut a same log positioned by the materials handling system substantially contemporaneously.

In one robotic saw workstation implementation, a third robotic manipulator and a third cutting head are further included. The programmable controller executes further stored instructions to instruct the third robot manipulator and third cutting head to make a third cut in the same log substantially contemporaneously with the first robot manipulator and first cutting head, the second robot manipulator and the second cutting head.

In one robotic saw workstation implementation, a fourth robotic manipulator and a fourth cutting head are further included. The programmable controller executes further stored instructions to instruct the fourth robot manipulator and fourth cutting head to make a fourth cut in the same log substantially contemporaneously with the first robot manipulator and first cutting head, the second robot manipulator and the second cutting head, and the third robotic manipulator and a third cutting head.

While implementations of the technology are disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the technology disclosed and the scope of the following claims. For example, different materials may be used to construct the press and its components; switches and controls can be placed in different configurations and/or positions. Some controls may be merged into single controls for simplification. Aural feedback can replace or augment visual indicators. Other colors and states for visual indicators may be used. Component values are recommendations, but can differ among implementations and individual units of a particular implementation due to manufacturing tolerances. Components may be sourced from different suppliers that provide parts of analogous functionality under different brand or type names.

One or more elements of one or more claims can be combined with elements of other claims. Any and all patents, patent applications and printed publications referred to above are incorporated by reference.

We claim as follows:

1. A robotic saw workstation for cutting logs, the robotic saw workstation comprising:
a robot manipulator capable of moving an end effector adapter plate to points in a three-dimensional work volume under programmed control of a programmable robot controller executing stored instructions;
a cutting head affixed to an end effector adapter plate, the cutting head further including:
a support structure;
a rotatable shaft;
a blade coupled to the rotatable shaft; and
a motor coupled to the rotatable shaft for driving the blade.

2. The robotic saw workstation according to claim 1, further including:
a materials handling system moving workpieces into the work volume and cutting workpieces out of the work volume.

3. The robotic saw workstation according to claim 2, further including a second robotic saw workstation, wherein the second robotic saw workstation is disposed relative to the materials handling system to cut a same log substantially contemporaneously with the robotic saw workstation of claim 2.

4. The robotic saw workstation according to claim 3, further including a third robotic saw workstation, wherein the third robotic saw workstation is disposed relative to the materials handling system to cut the same log substantially contemporaneously with the second robotic saw workstation and the robotic saw workstation of claim 3.

5. The robotic saw workstation according to claim 1, wherein the motor coupled to the rotatable shaft for driving the blade drives the blade at a speed within a selectable speed range that includes a speed of 0 revolutions per minute (rpm) to 1,750 rpm.

6. The robotic saw workstation according to claim 1, wherein a kerf cut by the blade in wood output from the robotic saw workstation is in a range between 0.125 inches to 0.75 inches.

7. The robotic saw workstation according to claim 1, wherein the blade is selected from at least one of a 54-inch blade, a 60-inch blade, and an 84-inch blade.

8. The robotic saw workstation according to claim 1, wherein the blade forms an angle between 1 degree and 10 degrees with respect to a vertical plane.

9. The robotic saw workstation according to claim 8, wherein the vertical plane is essentially orthogonal to a surface upon which the robotic saw workstation resides.

10. The robotic saw workstation according to claim 8, wherein the angle is inclined from the vertical plane to an input side of the robotic saw workstation.

11. The robotic saw workstation according to claim 8, wherein the angle is inclined from the vertical plane to an output side of the robotic saw workstation.

12. A method of cutting logs, the method comprising:
depositing the log on a materials handling system conveying the log into an infeed side of a work envelope of a robotic workstation, the robotic workstation having a manipulator for reaching points within the work envelope using a cutting tool affixed to an end effector thereof;
performing at least one cut of the log by the cutting tool as moved by the manipulator; and
removing a cut portion of the log from an outfeed side of the work envelope using the materials handling system.

13. The method according to claim 12, wherein the cutting tool operates at a speed within a selectable speed range that includes a speed of 0 revolutions per minute (rpm) to 1,750 rpm.

14. The method according to claim 12, further comprising performing multiple cuts to a log by multiple cooperatively acting cutting tools substantially contemporaneously.

15. The method according to claim 12, wherein the cutting is performed at an angle between 1 degree and 10 degrees with respect to a vertical plane.

16. The method according to claim 15, wherein the vertical plane is essentially orthogonal to a surface upon which the robotic saw workstation resides.

17. The method according to claim 15, wherein the angle is inclined from the vertical plane to an input side of the robotic saw workstation.

18. The method according to claim 15, wherein the angle is inclined from the vertical plane to an output side of the robotic saw workstation.

19. The method according to claim 12, further including using 3 robotic saws to saw a 40-foot log independently.

20. The method according to claim 12, wherein the log is approximately 55 feet long.

21. A cutting head affixed to an adapter plate of a robot manipulator capable of moving an end effector adapter plate to points in a three-dimensional work volume under programmed control of a programmable robot controller executing stored instructions for cutting logs, the cutting head comprising:
a support structure;
at least one rotatable shaft;
a sawblade including at least one of a circular blade, a chain blade, or band blade, and coupled to the at least one rotatable shaft and driven in a cutting motion; and
a motor coupled to the rotatable shaft for driving the blade.

22. A robotic saw workstation for cutting logs, the robotic saw workstation comprising:
a first robot manipulator capable of moving a first cutting head to points in a three-dimensional work volume under programmed control of a programmable controller executing stored instructions; wherein the first cutting head includes: a support structure; a rotatable shaft;
a blade coupled to the rotatable shaft; and a motor coupled to the rotatable shaft for driving the blade;
a second robot manipulator capable of moving a second cutting head to points in a three-dimensional work volume under programmed control of the programmable controller executing stored instructions; wherein the second cutting head includes: a support structure; a rotatable shaft; a blade coupled to the rotatable shaft; and a motor coupled to the rotatable shaft for driving the blade; and
a materials handling system moving workpieces into the work volume and cutting workpieces out of the work volume; and
wherein a programmable controller executing stored instructions instructs the first robot manipulator and first cutting head, the second robot manipulator and the second cutting head to cut substantially contemporaneously a same log positioned by the materials handling system.

23. The robotic saw workstation according to claim 22, further including a third robotic manipulator and a third cutting head; and
wherein the programmable controller executes further stored instructions to instruct the third robot manipulator and third cutting head to make a third cut in the same log substantially contemporaneously with the first robot manipulator and first cutting head, the second robot manipulator and the second cutting head.

24. The robotic saw workstation according to claim 23, further including a fourth robotic manipulator and a fourth cutting head; and
wherein the programmable controller executes further stored instructions to instruct the fourth robot manipulator and fourth cutting head to make a fourth cut in the same log substantially contemporaneously with the first robot manipulator and first cutting head, the second robot manipulator and the second cutting head, and the third robot manipulator and third cutting head.
